(19) United States
(12) Patent Application Publication
(10) Pub. No.: US 2020/0380413 A1
(43) Pub. Date: Dec. 3, 2020

(54) REINFORCEMENT LEARNING BASED RECOMMENDATION SYSTEM AND METHOD FOR APPLICATION CLIENTS

(71) Applicant: MZ IP HOLDINGS, LLC, Palo Alto, CA (US)

(72) Inventors: Wah Loon Keng, Mountain View, CA (US); Pidong Wang, Cupertino, CA (US); Karthik Jayasurya, Milpitas, CA (US); Brendan Burke, Palo Alto, CA (US); Christopher Lam, San Francisco, CA (US)

(21) Appl. No.: 16/845,198

(22) Filed: Apr. 10, 2020

Related U.S. Application Data
(60) Provisional application No. 62/856,536, filed on Jun. 3, 2019.

(51) Int. Cl. G06N 20/00

(52) U.S. Cl. CPC G06N 20/00

(57) ABSTRACT

Characteristics of a plurality of users of a client application are received. A recommendation model and a scaling model are generated based on the characteristics of the plurality of users. Recommendation scores are determined for the plurality of users using the recommendation model and scaling scores are determined for the plurality of users using the scaling model. One or more items of content are presented to one or more users of the plurality of users based on corresponding recommendation scores and scaling scores of the one or more users.

### CROSS-REFERENCE TO RELATED APPLICATIONS

This application claims the benefit of U.S. Provisional Patent Application No. 62/856,536, filed Jun. 3, 2019, the entire contents of which are incorporated by reference herein.

### BACKGROUND

Client applications, particularly games, can have deep, self-contained economy systems. For example, a video game application may have its own currency, items, boosters, etc. that have no inherent value outside of the virtual environment of the video game application. Client applications can provide in-app purchase offers to users of the client application. The in-app purchase offers allow the user to purchase objects for the self-contained economy systems using real world currency.

### DESCRIPTION OF THE DRAWINGS

FIG. 1 is a schematic diagram of an example content generation system for generating items of content of a client application.

FIG. 2 is an illustration of an example architecture for implementing a machine learning algorithm, in accordance with embodiments of the disclosure.

FIG. 3 is an illustration of an example of selecting a recommendation based on a recommendation score, in accordance with embodiments of the disclosure.

FIG. 4 is an illustration of an example of selecting a scaling factor based on a scaling score, in accordance with embodiments of the disclosure.

FIG. 5 is an illustration of an example of applying a scaling factor to a recommendation to generate an item of content, in accordance with embodiments of the disclosure.

FIG. 6 is an illustration of an example of identifying subsets of users for the determination of corresponding recommendation scores and scaling scores, in accordance with embodiments of the disclosure.

FIG. 7 is a block diagram illustrating an example method of generating items of content for presentation to users of a client application, in accordance with embodiments of the disclosure.

FIG. 8 is a block diagram of an example computing device.

### DETAILED DESCRIPTION

Aspects of the disclosure relate to intelligently generating items of content for a client application. In embodiments, the client application may include a self-contained economy. For example, the client application may be a massively multiplayer online (MMO) game that has its own currency, barter system, item values, etc. These client applications may provide in-app purchase offers (also referred to as “items of content” hereafter) that enable a user of the client application to purchase currency, items, etc. that exist within the client application's economy using real world currency. For example, an item of content may enable a user of the client application to purchase 1000 gold (e.g., the currency of the client application) for $10.00 (e.g., the real world currency).

In a conventional client application, a user may be inundated with items of content that do not necessarily fulfill a need of the user within the context of how the user interacts with the client application. For example, a new user of the client application may not necessarily need an item of content that includes high level items that are unusable by a new user of the client application. This results in a wasted sales opportunity, as items of content that are being presented are not valuable/useful for the user of the client application. Furthermore, as new currency, items, etc. are added to a client application, the relevance/real world values of currency, items, etc. may change drastically over a very short time period.

In conventional client applications, the real world currency value assigned to these items of content may not correlate to the correct value of the client application currency, items, etc. In some embodiments, the item of content may assign too low of a real world currency value to the item of content, sacrificing future revenue streams. For example, if an item of content provides a large amount of client application currency for a relatively low amount of real world currency, then a user who purchases the item of content may not need to purchase future items of content including the client application currency. In embodiments, the item of content may assign too high of a real world currency value to the item of content, reducing a number of users of the client application who purchase the item of content. For example, if an item of content provides a small amount of client application currency for a relatively high amount of real world currency, then fewer users will purchase the item of content.

In an attempt to mitigate some of these shortcomings, such items of content may be manually managed by developers of the conventional client applications. For example, developers of the client application may manually select the amounts/values assigned to the items of content that are provided to users of the client application. Such a process, however, requires analyzing large amounts of data, is time consuming, and is fraught with errors.

Aspects of the disclosure remedy the above and other deficiencies by implementing a content generation system that intelligently selects recommendations for a user of a client application and applies a real world value to the recommendation to generate an item of content. In an embodiment, the item of content may be an in-app sales or purchase offer that may enable a user of the client application to purchase currency or other virtual items that exist within the client application's economy or environment using, for instance, real world currency. In other words, the users can acquire items of content for use in the client application (e.g., by purchasing a sale offer). In embodiments, the processing logic of a processing device of a content generation system may utilize one or more machine learning models/algorithms, such as one or more reinforcement learning (RL) models, to receive and analyze characteristics associated with users of a client application.

The processing logic may implement a recommendation model that selects the most relevant recommendations for a particular user based on a recommendation score. A recommendation may include items, currency, boosters, etc. of a client application that are to be utilized as part of an item of content. For example, a recommendation may indicate that an item of content should include 1000 gold of client application currency and 5 experience boost items. A particular recommendation may be selected for a user of the client application based on a corresponding recommendation score that has been calculated for the user. The recommendation score may be determined based on characteristics associated with the user. The characteristics may be any sort of property, parameter, metric, etc. that may be attributable to the user of the client application. For example, in a video game application, characteristics may be character level, building level, combat power, battle history, user alliance, player experience, user purchase history, etc.

The processing logic may implement a scaling model. In embodiments, the scaling model may compensate for the inflation or deflation of the self-contained economy of the client application based on a scaling score. Similar to a real world economy, a self-contained economy of a client application may experience inflation or deflation. The values of the client application currency, items, etc. in real world currency may fluctuate over time, and in most cases much more rapidly than in a real world economy. For example, an item in a client application may be worth $4.99 in real world currency on one day, and $2.99 in real world currency on a different day. Accordingly, various characteristics associated with users and/or the client application may be used to determine a scaling score. The scaling score may be used to determine a scaling factor that may be applied to the recommendation. The scaling factor may be applied to the recommendation to modify the values included in an item of content that is presented to a user. For example, the scaling factor may increase/decrease the amount of client application currency, a number of items, and/or the amount of real world currency used in an item of content that is to be presented to a user of the client application.

Upon selecting a recommendation using the recommendation model and determining a scaling factor using the scaling model, the processing logic may generate an item of content. The item of content may be a recommendation that has had the scaling factor applied to it to adjust the values of the selected recommendation. The generated item of content may then be provided to a client device of the user of the client application for presentation by the client device.

Utilizing a recommendation model and a scaling model to generate items of content enables a more efficient process to provide relevant items of content to users of a client application while minimizing manual oversight of the preparation and generation of items of content by developers of the client application. By utilizing the recommendation model to select recommendations based on user characteristics, the recommendations are more likely to be useful/relevant for a user of the client application. Furthermore, by utilizing the scaling model to select an appropriate scaling factor for the recommendation, the proper correlation of the values of the client application economy with real world currency is improved.

Although examples of the disclosure may be described in the context of a video game application, such examples are for illustrative purposes only. Aspects of the disclosure may be utilized by any client applications that use any kind of product recommendation and/or item of content generation. For example, aspects of the disclosure may be used by retail applications that provide product recommendations and/or items of content to users. In another example, aspects of the disclosure may be used by any client application that includes a self-contained economy.

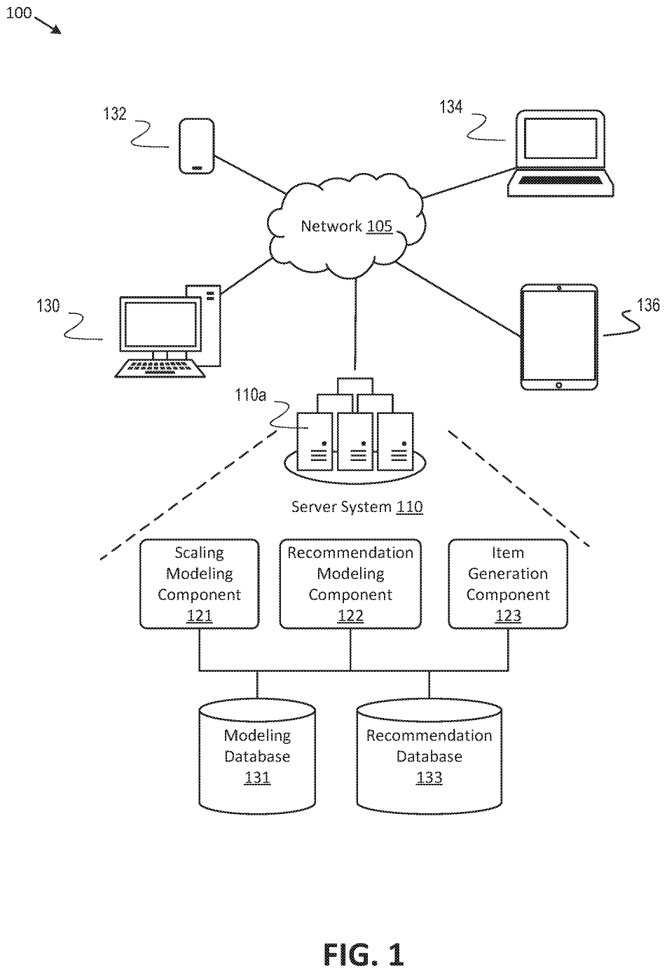

FIG. 1 is a schematic diagram of an example content generation system 100 for generating items of content of a client application. A server system 110 including one or more servers 110a provides functionality for operating and managing an online application used by users via client devices 130-136, including installs of an online application (e.g., mobile application, gaming application, mobile gaming application), facilitating user interactions, introducing features, and any other suitable operation. The server system 110 includes software components and databases that can be deployed at one or more data centers in one or more geographic locations. In certain instances, the server system 110 is, includes, or utilizes a content delivery network (CDN). The server system 110 may include one or more software components, including a scaling modeling component 121, a recommendation modeling component 122, an item generation component 123, and any other suitable component for fulfilling the methods discussed herein. The software components can include subcomponents that can execute on the same or on different individual data processing apparatus. The server system 110 databases can include modeling database 131 and a recommendation database 133, and any suitable number of other databases that are not illustrated in FIG. 1, such as a features database, a payments database, or an authentication database. The databases can reside in one or more physical storage systems. The software components and data will be further described below.

A client application, such as a web-based application, can be provided as an end-user application to allow users to interact with the server system 110 and with other users of the server system 110 via the application. The client application or components thereof can be accessed through a network 105 (e.g., the Internet) by users of client devices, such as a personal computer 130, a smart phone 132, a laptop computer 134, or a tablet computer 136. Other client devices are possible. Additionally, or alternatively, software components for the system 100 (e.g., the scaling modeling component 121, the recommendation modeling component 122, the item generation component 123) or any portions thereof can reside on or be used to perform operations on one or more client devices.

The content generation system 100 includes the scaling modeling component 121, the recommendation modeling component 122, and the item generation component 123 as being able to communicate with the modeling database 131 and the recommendation database 133. The modeling database 131 may include one or more data structures storing received characteristics of users of client applications and/or other characteristics to be used by the content generation system 100, such as characteristics used by a recommendation model and/or scaling model. The modeling database 131 may further include different scaling models and/or recommendation models that are used to determine scaling scores and recommendation scores for users, respectively. The recommendation database 133 may include one or more recommendations that may be used to generate an item of content by the content generation system 100. In embodiments, the recommendations may include a user interface, such as a graphical user interface (GUI), which presents a listing of objects associated with the client application that may be purchased for real world currency.

The scaling modeling component 121 may be responsible for identifying particular characteristics associated with a client application from the modeling database 131 that are utilized by one or more scaling models. The scaling modeling component 121 may input the characteristics into the scaling model to determine a scaling score for a user of the client application. In embodiments, the scaling model may be a machine learning algorithm, such as a RL algorithm. The scaling modeling component 121 may select a scaling factor to be applied to a recommendation based on the determined scaling score of a user.

The recommendation modeling component 122 may be responsible for identifying particular characteristics associated with users of a client application that are utilized by one or more recommendation models. The recommendation modeling component 122 may input the characteristics into the recommendation model to determine a recommendation score for a user of the client application. In embodiments, the recommendation model may be a machine learning algorithm, such as an RL algorithm. The recommendation modeling component 122 may select one or more recommendations from the recommendation database 133 to be used to generate an item of content based on the determined recommendation score.

The item generation component 123 may be responsible for generating an item of content based on the scaling score and the recommendation score determined by the scaling modeling component 121 and the recommendation modeling component 122, respectively. In embodiments, the item generation component 123 may generate an item of content by applying a scaling factor that is selected by the scaling modeling component 121 to a recommendation selected by the recommendation modeling component 122. The item generation component 123 may then provide the generated item of content to a client device associated with the user of the client application.

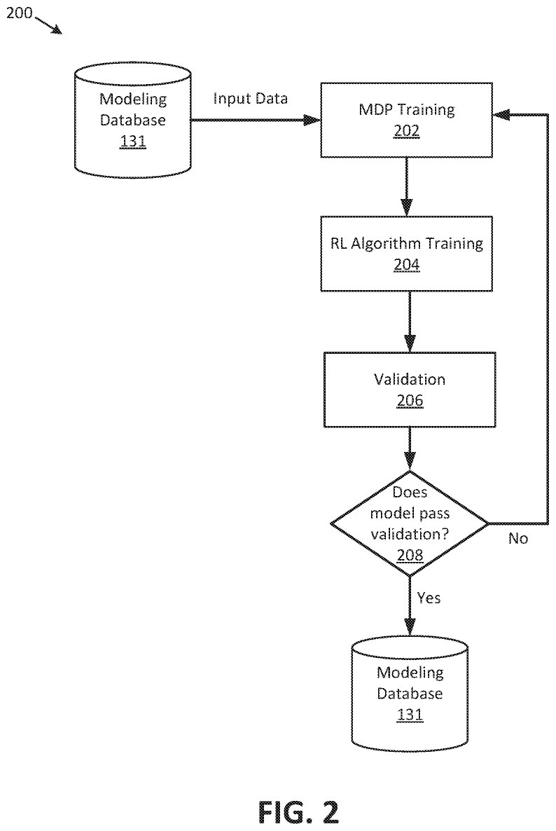

FIG. 2 is an illustration of an example architecture 200 for implementing a machine learning algorithm, in accordance with embodiments of the disclosure. In embodiments, architecture 200 may be utilized to generate and train a recommendation model and/or scaling model utilized by aspects of the disclosure. Aspects of the example architecture may be performed by one or more components of server system 110 of FIG. 1.

In the example architecture 200, input data is provided from the modeling database 131 for training a Markov Decision Process (MDP) (e.g., MDP training 202). The MDP provides a mathematical framework for modeling decision making in situations where outcomes are partly random, but also partly under control by a decision maker. In embodiments, the input data may be a training set used to train the MDP by determining appropriate values for the weights and biases of the MDP to minimize loss using examples included in the training set.

Upon completion of the MDP training 202, output data from the MDP is utilized in a reinforcement learning (RL) training process (e.g., RL algorithm training 204). In embodiments, the reinforcement learning may be a machine learning algorithm that determines how software components/agents ought to take actions in an environment in order to maximize one or more parameters. For example, the RL may determine how items of content are to be generated to maximize user engagement, profit, etc. In some embodiments, the environment of the RL may be stated in the form of an MDP. Similar to MDP training 202, the RL algorithm training 204 set may train the RL model by determining appropriate values for the weights and biases of the RL model using examples included in the training set.

Upon completion of the MDP training 202 and the RL algorithm training 204, the model may undergo a validation 206 process. In embodiments, the validation 206 may include providing a validation set of data to the model. The resulting outputs of the model may be compared to expected outputs included in the validation set of data to determine whether the model is functioning properly. For example, if the outputs of the model are within a threshold value, or the decisions made by the model are similar to the expected outputs of the validation set, then the model may be validated.

Upon performing the validation 206, the architecture 200 may determine if the model passed the validation (block 208). If the model did not pass the validation, then the training process may be repeated until a valid model is generated. If the model did pass the validation, then the model may be stored in the modeling database 131 for subsequent use by the content generation system 100 of FIG. 1.

It should be noted that the models/algorithms/processes discussed above are used for illustrative purposes only. Embodiments of the disclosure may utilize other types of models, machine learning algorithms, processes, etc. to generate items of content as described in the present disclosure.

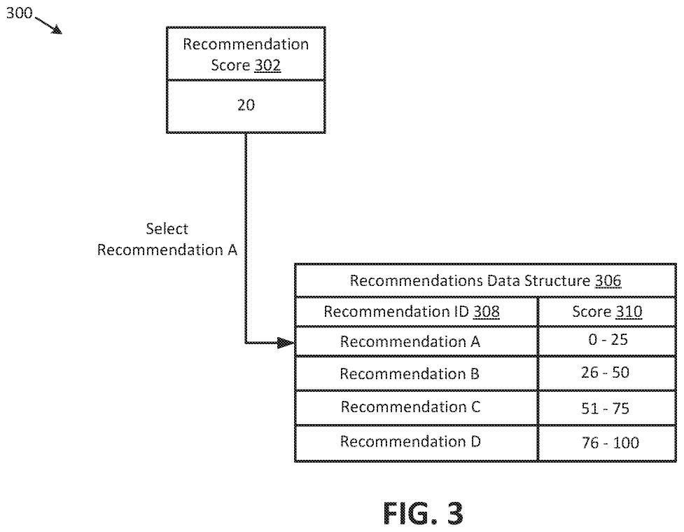

FIG. 3 is an illustration 300 of an example of selecting a recommendation based on a recommendation score, in accordance with embodiments of the disclosure. In embodiments, aspects of illustration 300 may be performed by recommendation modeling component 122 of FIG. 1.

As previously described, characteristics associated with a user of a client application may be received by a content generation system. For example, in a video game application, a user's level, battle history, items, amount of client application currency, purchase history, etc. may be received by the content generation system. The received characteristics may be used as inputs for a recommendation model to determine a recommendation score 302 for the user. The recommendation score 302 may be used by the recommendation model to select one or more appropriate recommendations for the user. For example, the recommendation score 302 may indicate that a user of the client application is relatively new. Accordingly, the recommendation score 302 may be used by the recommendation model to select a recommendation that is more tailored towards new users of the client application. Similarly, if the recommendation score 302 indicates that a user of the client application is an experienced user, the recommendation score 302 may be used by the recommendation model to select a recommendation that is more tailored towards experienced users of the client application.

In embodiments, the recommendation model may use the recommendation score 302 to select one or more recommendations from a recommendations data structure 306. In an embodiment, the recommendations data structure 306 may be stored at the recommendation database 133 of FIG. 1. The recommendations data structure 306 may include a listing of recommendations available for a client application. The recommendations data structure 306 may include a recommendation identifier (e.g., recommendation ID 308) for each recommendation of the client application and a corresponding score 310 of each of the recommendations. The score 310 may include a range of numerical values that may correspond to recommendation scores determined for users of a client application by a recommendation model.

Referring to FIG. 3, the recommendation score 302 determined for the user is a value of 20. To select one or more recommendations for the user, the recommendation model may query the recommendations data structure 306 to identify recommendations for a user having a recommendation score 302 value of 20. Because Recommendation A has a score 310 range of 0-25, the recommendation model may select Recommendation A based on the recommendation score 302 for the user.

It should be noted that although FIG. 3 illustrates a recommendations data structure 306 including four recommendations each having four distinct ranges of scores 310, aspects of the disclosure may utilize any number of recommendations having any combination of different ranges of scores 310. For example, recommendations data structure 306 may include different recommendations having all or a portion of the ranges of scores 310 overlapping with one another. In such cases where the recommendation score 302 falls within these overlapping sections of scores 310, multiple recommendations may be selected for the user.

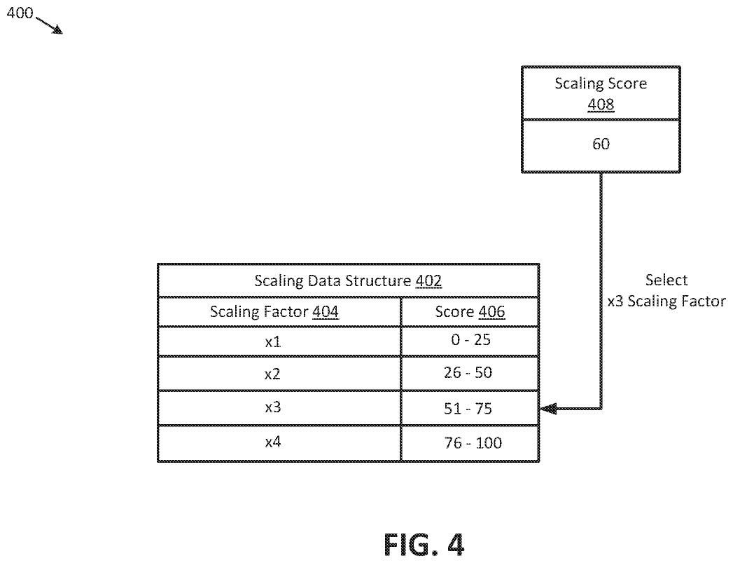

FIG. 4 is an illustration 400 of an example of selecting a scaling factor based on a scaling score, in accordance with embodiments of the disclosure. In embodiments, aspects of illustration 400 may be performed by scaling modeling component 121 of FIG. 1.

As previously described, characteristics may be received by a content generation system. In some embodiments, the characteristics may be characteristics associated with a user of the client application. For example, in a video game application, a user's level, battle history, items, amount of client application currency, a user's spending history, etc. may be received by the content generation system.

In embodiments, the characteristics may be characteristics associated with the client application. For example, the characteristics may include information associated with the self-contained economies of one or more distinct servers, hosting separate virtual instances of a client application. In an example scenario, a video game application may be sequentially instantiated on new servers, where each new server hosts its own virtual environment and self-contained economy. For example, a first server may host a first instance of a video game application. As more users begin playing the video game application and the first server nears capacity, a new instance of the video game application may be instantiated on a second server. Upon instantiation, new users joining the video game application may be hosted by the second server rather than the first server. Such self-contained economies may also be the result of different cohorts or group of users within, for example, a virtual instance of the client application, where each cohort has an economy that is different from the economies of other cohorts.

This may result in the self-contained economies of each of these servers (or cohorts) being at different stages of inflation. For example, an older server (or cohort) may have a more developed economy with more experienced users and, thus, may experience a lower rate of inflation, while a new server (or cohort) may have a less developed economy with less experienced users may experience a higher rate of inflation.

In some embodiments, the characteristics may include historical data of related servers/instances/cohorts of a client application. Historical data associated with a self-contained economy of an older server (or cohort) may be used to predict the behaviors of the self-contained economy of a newer server (or cohort). For example, if the self-contained economy of an older server experienced a 10% inflation rate over a two-month period of time, then the content generation system may predict that the new server will also experience around a 10% inflation rate over a corresponding two-month period of time.

Upon receiving the characteristics, a scaling score 408 may be determined for a user. The scaling score 408 may be used by the scaling model to select one or more appropriate scaling factors for the user. For example, the scaling score 408 may indicate that a user of a video game application is on a server (or cohort) that is experiencing a high rate of inflation. Accordingly, the scaling score 408 may be used by the scaling model to select a higher scaling factor. Similarly, if the scaling score 408 indicates that a user of the video game application is on a server (or cohort) that is experiencing a low rate of inflation, the scaling score 408 may be used by the scaling model to select a lower scaling factor.

In embodiments, the scaling model may use the scaling score 408 to select one or more scaling factors from a scaling data structure 402. The scaling data structure 402 may include a listing of scaling factors to be applied to recommendations of a client application. The scaling data structure 402 may include scaling factors 404 to be applied to the recommendations of a client application and a corresponding score 406 of each of the scaling factors. The score 406 may include a range of numerical values that may correspond to scaling scores determined for users of a client application by a scaling model.

Referring to FIG. 4, the scaling score 408 determined for the user is a value of 60. To select one or more scaling factors for the user, the scaling model may query the scaling data structure 402 to identify scaling factor(s) for a user having a scaling score 408 value of 60. Because scaling factor x3 has a score 406 range of 51-75, the scaling model may select scaling factor x3 based on the scaling score 408 for the user.

Although illustrated has having a single scaling factor 404 for each corresponding range of scores 406, aspects of the disclosure may utilize any number of scaling factors for any number of scores 406. For example, a particular score or range of scores may have a first scaling factor that is applied to a first item of a recommendation, a second scaling factor that is applied to a second item of a recommendation, and/or a third scaling factor that is applied to the real world currency value of the recommendation.

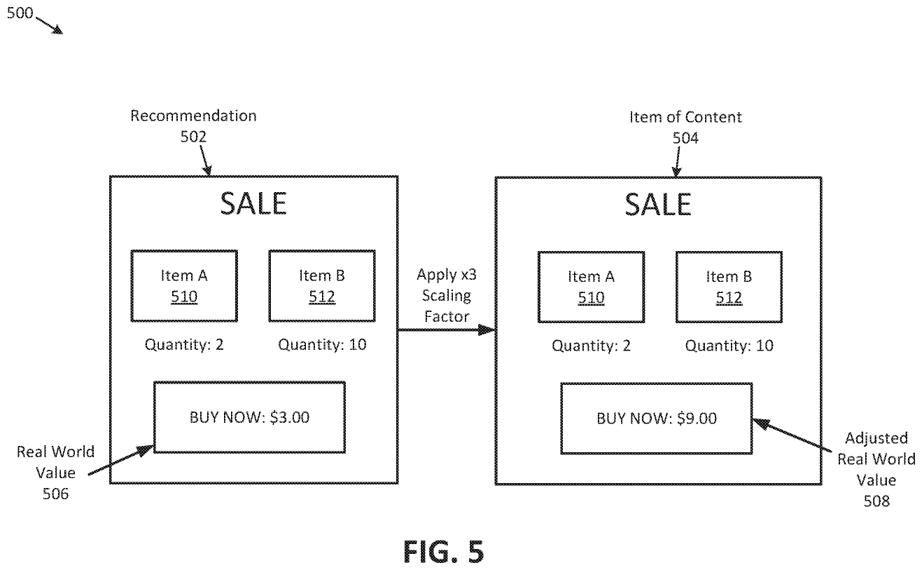

FIG. 5 is an illustration 500 of an example of applying a scaling factor to a recommendation to generate an item of content, in accordance with embodiments of the disclosure. As previously described at FIGS. 3 and 4, a content generation system may select a recommendation 502 based on a recommendation score of a user and a scaling factor based on a scaling score of the user. For example, recommendation 502 may correspond to Recommendation A selected at FIG. 3 and the scaling factor may be the x3 scaling factor selected at FIG. 4. The scaling factor may be applied to one or more values of the recommendation 502 to generate an item of content 504. The item of content 504 may include the contents of the recommendation 502 that have been adjusted for inflation using the selected scaling factor.

The recommendation 502 may include item A 510 and item B 512 that correspond to objects associated with a client application. For example, item A 510 may correspond to client application currency and item B 512 may correspond to an item that is usable within the client application. The recommendation 502 may also include a corresponding quantity of item A 510 and item B 512. The recommendation 502 may also include a real world value 506 for the items (e.g., item A 510 and item B 512) included in the recommendation 502.

Referring to FIG. 5, recommendation 502 includes a quantity of 2 for item A 510, a quantity of 10 for item B 512, and a real world value 506 of $3.00. To generate the item of content 504, the scaling factor is applied to the real world value 506 of recommendation 502 to produce an adjusted real world value 508 to be included in the item of content 504. For example, the x3 scaling factor may be applied to the real world value 506 of $3.00 to produce an adjusted real world value 508 of $9.00 (e.g., real world value 506 multiplied by a scaling factor of 3) for the item of content 504. Upon applying the scaling factor, the item of content 504 may be provided to a client device of the user for presentation to the user.

In embodiments, the scaling factor(s) may be applied for multiple values of recommendation 502. For example, the scaling factor may be applied to real world value 506 and the quantity of item A 510. Accordingly, the generated item of content 504 would have an adjusted real world value 508 of $9.00 and the quantity of item A 510 may be adjusted from 2 to 6. In another example, a first scaling factor of x2 may be applied to the quantity of item A 510 and a second scaling factor of x3 may be applied to the real world value 506. Accordingly, the generated item of content 504 would have an adjusted real world value 508 of $9.00 and the quantity of item A 510 may be adjusted from 2 to 4.

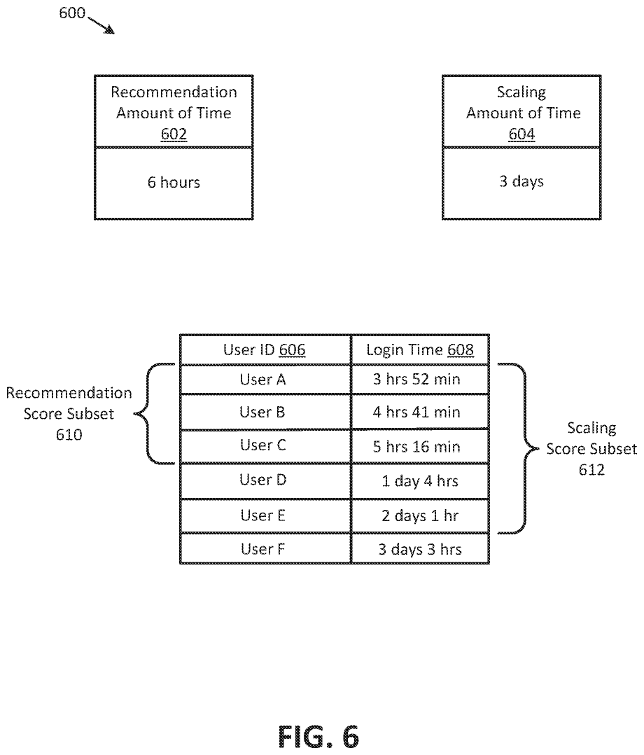

FIG. 6 is an illustration 600 of an example of identifying subsets of users for the determination of corresponding recommendation scores and scaling scores, in accordance with embodiments of the disclosure. In some embodiments, to preserve processing overhead of the content generation system, subsets of users may be identified for the determination of corresponding recommendation and/or scaling scores. For example, relevant recommendations that are to be provided to users may change more rapidly than the inflation of a client application. Accordingly, a recommendation score calculated for a user on one day may no longer be relevant on the following day, while the scaling score calculated on one day may still be relevant the following day. To prevent unnecessary scores from being determined, subsets of users may be identified based on their most recent login time 608 for a client application.

The content generation system may utilize a recommendation amount of time 602 and/or a scaling amount of time 604 to identify subsets of users for the determination of corresponding recommendation scores and/or scaling scores, respectively. In embodiments, the recommendation amount of time 602 and/or the scaling amount of time 604 may correspond to time thresholds used to identify subsets of users of a client application. For example, if the recommendation amount of time 602 is 6 hours, then the recommendation amount of time 602 may be used to identify a subset of users that have logged in to the client application within the last 6 hours. Similarly, if the scaling amount of time 604 is 3 days, then the scaling amount of time 604 may be used to identify a subset of users that have logged into the client application within the last 3 days. User login information may be stored in a data structure that includes user identifications (e.g., User ID 606) and a corresponding login time 608 for each of the users.

Referring to FIG. 6, the recommendation amount of time 602 is 6 hours. Accordingly, the recommendation score subset 610 may include User A, User B, and User C, because these users have corresponding login times 608 that are less than 6 hours. Upon identifying the recommendation score subset 610, the content generation system may determine a corresponding recommendation score for each of the users of the recommendation score subset 610. For example, the content generation system may determine a first recommendation score for User A, a second recommendation score for User B, and a third recommendation score for User C.

The scaling amount of time 604 is 3 days. Accordingly, the scaling score subset 612 may include User A, User B, User C, User D, and User E, because these users all have corresponding login times 608 that are less than 3 days. Upon identifying the scaling score subset 612, the content generation system may determine a corresponding scaling score for each of the users of scaling score subset 612. For example, the content generation system may determine a first recommendation score for User A, a second recommendation score for User B, a third recommendation score for User C, a fourth recommendation score for User D, and a fifth recommendation score for User E. Because the login time 608 of User F is not within the recommendation amount of time 602 or the scaling amount of time 604, User F may not be included in either of the recommendation score subset 610 or the scaling score subset 612. Accordingly, a corresponding recommendation score and scaling score may not be determined for User F.

In some embodiments, rather than determining the recommendation scores and/or scaling scores for subsets of users, the content generation system may determine the recommendation scores and/or scaling scores at a determined frequency. In embodiments, the content generation system may determine the recommendation scores at a first frequency and the scaling scores at a second frequency. For example, the content generation system may determine recommendation scores after six hours has elapsed since previously determining recommendation scores and/or the content generation system may determine scaling scores after one day has elapsed since previously determining scaling scores. In some embodiments, because relevant recommendations that are to be provided to users may change more rapidly than the inflation of a client application, the frequency at which recommendation scores are determined may be higher (e.g., performed more often) than the frequency at which scaling scores are determined.

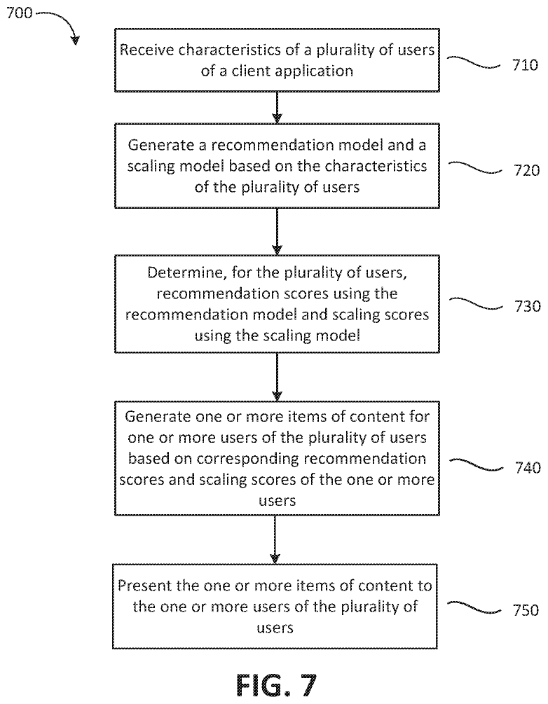

FIG. 7 is a block diagram illustrating an example method 700 of generating items of content for presentation to users of a client application, in accordance with embodiments of the disclosure. In general, the method 700 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. For example, the processing logic may be implemented as scaling model component 121, recommendation model component 122 and/or item generation component 123.

Method 700 may begin at block 710, where the processing logic receives characteristics of a plurality of users of a client application.

At block 720, the processing logic generates a recommendation model and a scaling model based on the characteristics of the plurality of users. In embodiments, the recommendation model and/or scaling model may be machine learning algorithms, such as RL algorithms, that are trained and validated as previously described at FIG. 2.

At block 730, the processing logic determines, for the plurality of users, recommendation scores using the recommendation model and scaling scores using the scaling model.

At block 740, the processing logic generates one or more items of content for one or more users of the plurality of users based on corresponding recommendation scores and scaling scores of the one or more users. In embodiments, the processing logic may generate an item of content by selecting a recommendation based on a recommendation score of a user and applying a scaling factor, determined based on the scaling score, to the recommendation to generate the item of content.

At block 750, the processing logic presents the one or more items of content to the one or more users of the plurality of users. In embodiments, the processing logic may present the items of content to the one or more users by providing the items of content to corresponding client devices of the one or more users of the plurality of users. For example, the processing logic may transmit the one or more items of content to client devices (e.g., client devices 130-136 of FIG. 1) of the one or more users via a network (e.g., network 105 of FIG. 1). The one or more users may then engage with the one or more items of content. For example, the users may engage with the one or more items of content by making a purchase.

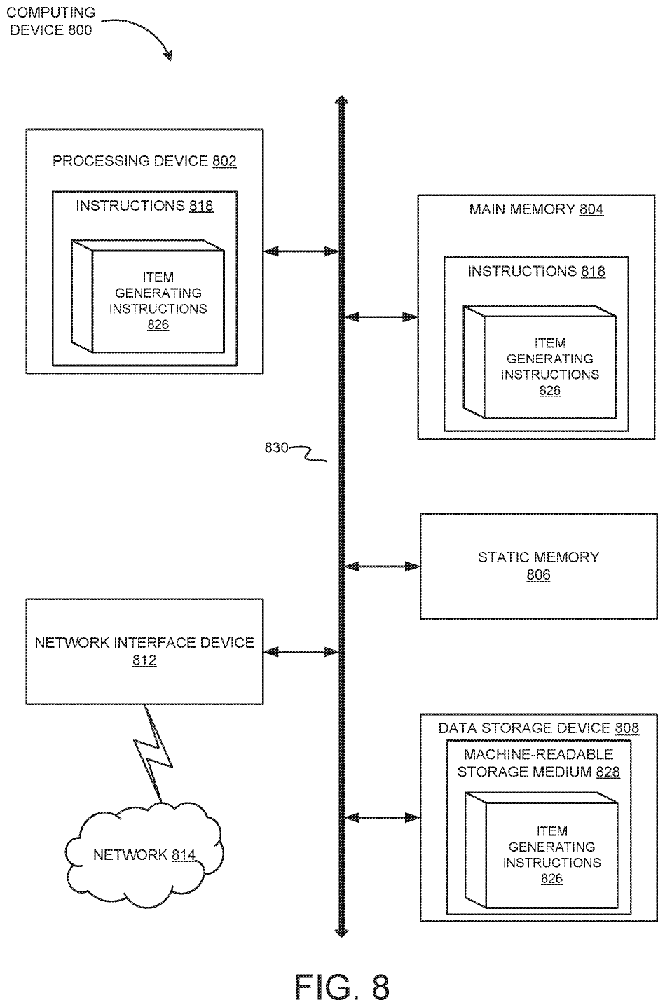

FIG. 8 is a block diagram of an example computing device 800 that may perform one or more of the operations described herein, in accordance with the present embodiments. The computing device 800 may be connected to other computing devices in a LAN, an intranet, an extranet, and/or the Internet. The computing device 800 may operate in the capacity of a server machine in client-server network environment or in the capacity of a client in a peer-to-peer network environment. The computing device 800 may be provided by a personal computer (PC), a set-top box (STB), a server, a network router, switch or bridge, or any machine capable of executing a set of instructions (sequential or otherwise) that specify actions to be taken by that machine. Further, while only a single computing device 800 is illustrated, the term “computing device” shall also be taken to include any collection of computing devices that individually or jointly execute a set (or multiple sets) of instructions to perform the methods discussed herein.

The example computing device 800 may include a computer processing device (e.g., a general purpose processor, ASIC, etc.) 802, a main memory 804, a static memory 806 (e.g., flash memory and a data storage device 808), which may communicate with each other via a bus 830. The computer processing device 802 may be provided by one or more general-purpose processing devices such as a microprocessor, central processing unit, or the like. In an illustrative example, computer processing device 802 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 802 may also comprise one or more special-purpose processing devices such as an application specific integrated circuit (ASIC), a field programmable gate array (FPGA), a digital signal processor (DSP), network processor, or the like. The computer processing device 802 may be configured to execute the operations described herein, in accordance with one or more aspects of the present disclosure, for performing the operations and steps discussed herein.

The computing device 800 may further include a network interface device 812, which may communicate with a network 814. The data storage device 808 may include a machine-readable storage medium 828 on which may be stored one or more sets of instructions, e.g., instructions for carrying out the operations described herein, in accordance with one or more aspects of the present disclosure. Instructions 818 implementing item generating instructions 826 may also reside, completely or at least partially, within main memory 804 and/or within computer processing device 802 during execution thereof by the computing device 800, main memory 804 and computer processing device 802 also constituting computer-readable media. The instructions may further be transmitted or received over the network 814 via the network interface device 812.

While machine-readable storage medium 828 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, or solid state drives. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method, comprising:
receiving characteristics of a plurality of users of a client application;
generating a recommendation model and a scaling model based on the characteristics of the plurality of users;
determining, for the plurality of users, recommendation scores using the recommendation model and scaling scores using the scaling model; and
presenting, by a computer processing device, one or more items of content to one or more users of the plurality of users based on corresponding recommendation scores and scaling scores of the one or more users.

2. The method of claim 1, wherein at least one of the recommendation model or the scaling model comprises a reinforcement learning algorithm.

3. The method of claim 1, wherein presenting the one or more items of content further comprises:
providing the one or more items of content to corresponding client devices of the one or more users of the plurality of users.

4. The method of claim 1, wherein the recommendation score is determined at a first frequency and the scaling score is determined at a second frequency that is different than the first frequency.

5. The method of claim 4, wherein the first frequency is greater than the second frequency.

6. The method of claim 1, wherein determining, for the plurality of users, the recommendation scores using the recommendation model and the scaling scores using the scaling model further comprises:
identifying a first subset of users of the plurality of users having accessed the client application within a first amount of time;
determining the corresponding recommendation scores for the first subset of users;
identifying a second subset of users of the plurality of users having accessed the client application within a second amount of time that is different than the first amount of time; and
determining the corresponding scaling scores for the second subset of users.

7. The method of claim 6, wherein the first amount of time is less than the second amount of time.

8. The method of claim 1, wherein the client application comprises a self-contained economy and wherein the one or more items of content are based on the self-contained economy.

9. The method of claim 1, wherein the client application comprises a video game application.

10. A system, comprising:
a memory; and
a computer processing device, operatively coupled to the memory, to:
receive characteristics of a plurality of users of a client application;
generate a recommendation model and a scaling model based on the characteristics of the plurality of users;
determine, for the plurality of users, recommendation scores using the recommendation model and scaling scores using the scaling model; and
present one or more items of content to one or more users of the plurality of users based on corresponding recommendation scores and scaling scores of the one or more users.

11. The system of claim 10, wherein at least one of the recommendation model or the scaling model comprises a reinforcement learning algorithm.

12. The system of claim 10, wherein to present the one or more items of content, the computer processing device is further to:
provide the one or more items of content to corresponding client devices of the one or more users of the plurality of users.

13. The system of claim 10, wherein the recommendation score is determined at a first frequency and the scaling score is determined at a second frequency that is different than the first frequency.

14. The system of claim 13, wherein the first frequency is greater than the second frequency.

15. The system of claim 10, wherein to determine, for the plurality of users, the recommendation scores using the recommendation model and the scaling scores using the scaling model, the computer processing device is further to:
identify a first subset of users of the plurality of users having accessed the client application within a first amount of time;
determine the corresponding recommendation scores for the first subset of users;
identify a second subset of users of the plurality of users having accessed the client application within a second amount of time that is different than the first amount of time; and
determine the corresponding scaling scores for the second subset of users.

16. The system of claim 15, wherein the first amount of time is less than the second amount of time.

17. The system of claim 10, wherein the client application comprises a self-contained economy and wherein the one or more items of content are based on the self-contained economy.

18. The system of claim 10, wherein the client application comprises a video game application.

19. A non-transitory computer-readable medium having instructions stored thereon that, when executed by a computer processing device, cause the computer processing device to:
receive characteristics of a plurality of users of a client application;
generate a recommendation model and a scaling model based on the characteristics of the plurality of users;
determine, for the plurality of users, recommendation scores using the recommendation model and scaling scores using the scaling model; and
present, by the computer processing device, one or more items of content to one or more users of the plurality of users based on corresponding recommendation scores and scaling scores of the one or more users.

20. The non-transitory computer-readable medium of claim 19, wherein at least one of the recommendation model or the scaling model comprises a reinforcement learning algorithm.
